(19) United States
(12) Patent Application Publication
(10) Pub. No.: US 2025/0164055 A1
(43) Pub. Date: May 22, 2025

(54) MULTI-DIMENSIONAL SPACER

(71) Applicant: A-Lok Products Inc., Tullytown, PA (US)

(72) Inventors: James J. Mirales, Chalfont, PA (US); James A. Westhoff, Langhorne, PA (US)

(73) Assignee: A-Lok Products Inc., Tullytown, PA (US)

(21) Appl. No.: 18/514,371

(22) Filed: Nov. 20, 2023

Related U.S. Application Data
(60) Provisional application No. 63/426,942, filed on Nov. 21, 2022.

(51) Int. Cl. F16L 55/00; B29C 48/11; E01C 23/00

(52) U.S. Cl. CPC F16L 55/00; E01C 23/00; B29C 48/11

(57) ABSTRACT

A multi-dimensional body has opposed surfaces that are spaced apart to define a thickness for the multi-dimensional body. Each of the opposed surfaces has a geometric shape that includes no more than three right angles. A body portion that extends between the opposed surfaces conforms to the geometric shape of the opposed surfaces.

### FIELD OF INVENTION

The invention relates most broadly to a spacer for use in the construction industry. The invention relates more particularly to a spacer used in assembling components that will be joined with an adhesive material. The invention relates most particularly to assembling components that are used in water control systems and municipal sewer systems.

### BACKGROUND

Currently, contractors often use sticks, stones, broken concrete, or broken brick pieces to wedge within the opening to support the spacing in the components prior to grouting. This is time consuming and lacks an engineered solution for suspending or aligning the component within the opening. It also leads to poor installation alignment that can lead to damage from leakage in the bedding around the structure or roadway.

### SUMMARY

The present solution provides multi-dimensional spacers that can be set within the spaces between components in various orientations so the space can be filled with an adhesive, like caulk, grout, and cement.

### BRIEF DESCRIPTION OF THE DRAWINGS

FIGS. 1A through 7B illustrate various multi-dimensional spacers;

FIG. 8 illustrates some multi-dimensional spacers in an opening in a support member that may be found water control systems and municipal sewer systems;

and,

FIG. 9 illustrates spacers positioned to level a cover slab or grate that is part of the water control systems and municipal sewer systems.

### DETAILED DESCRIPTION

In the following description and claims, “multi-dimensional geometries” means three dimensional bodies that have spaced apart opposed surfaces with no more than three right angles, i.e. they are not comprised of all right angles like a box, and the portion of the three dimensional body between the opposed surfaces are not defined by a single diameter, i.e. they are not like a circle or a sphere.

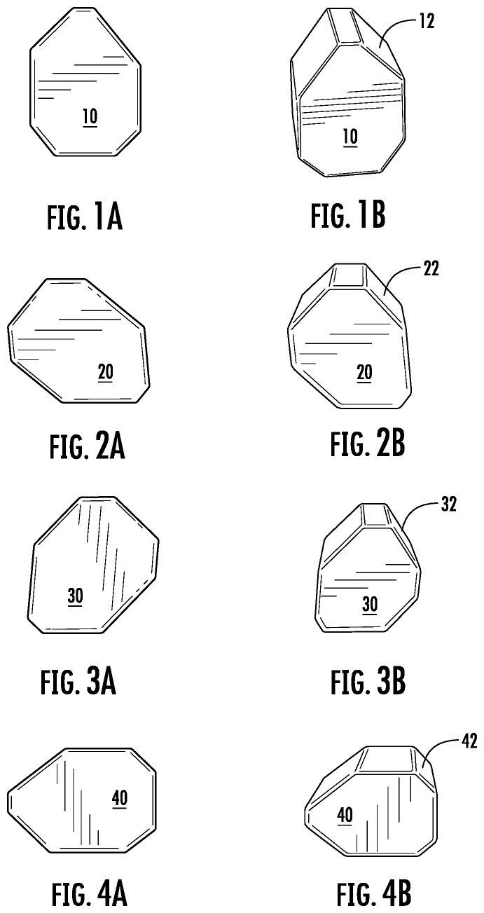

In the following description like numerals identify common or similar elements of the multi-dimensional geometric bodies. In FIGS. 1A through 6B, each of the bodies has opposed faces or surfaces (10, 20, 30, and 40), that define a thickness for the respective body. Extending between the opposed surfaces (10, 20, 30, and 40), are body portions (12, 22, 32, and 42), that extend for the thickness of the respective body and follow or conform to the geometry of the opposed surfaces (10, 20, 30, and 40).

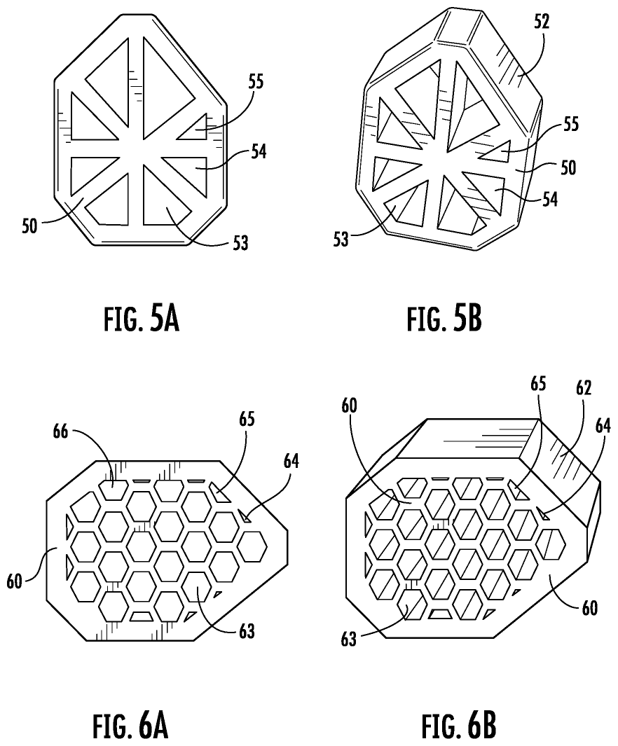

In FIGS. 5A through 6B, each of the bodies has opposed faces or surfaces (50, and 60), that define a thickness for the respective body. Extending between the opposed surfaces (50, and 60), are body portions (52, and 62), that extend for the thickness of the respective body and follow or conform to the geometry of the opposed surfaces (50, and 60). These embodiments differ from those in FIGS. 1A through 6B in that they are honeycombed with a plurality of interstices (53, 54, and 55; 63, 64, 65 and 66) that may be of different sizes.

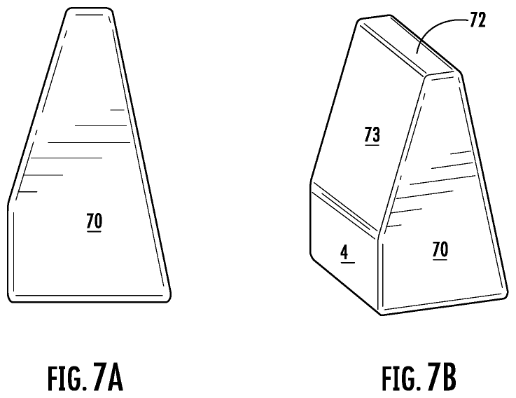

With reference to FIGS. 7A and 7B, the opposed faces or surfaces 70 define a body 72 between them that has an upper portion 73 that is angled with respect to the lower portion 74, which is generally vertical. This configuration with the longer portion 73 can be used much like a wedge in the application the more multisided geometric bodies may not be sufficient.

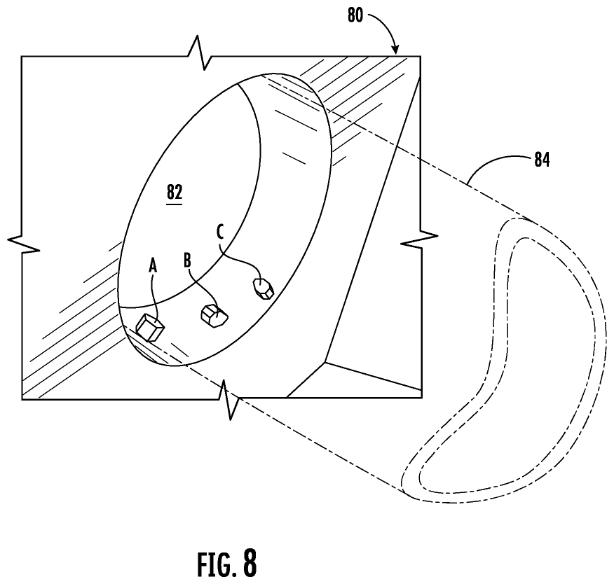

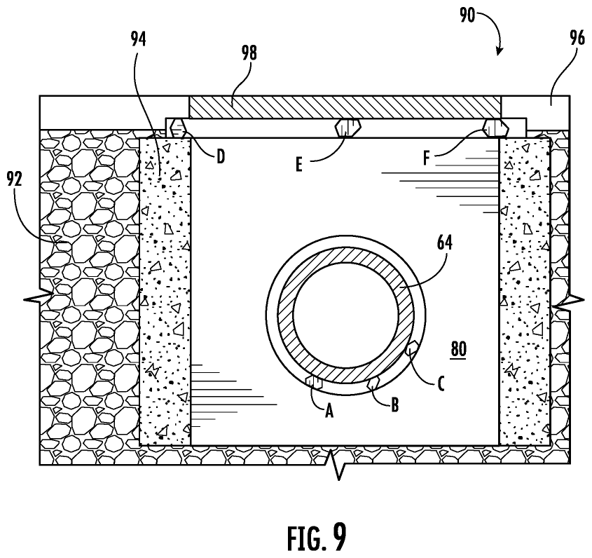

With reference to FIG. 8, the use of multi-dimensional geometric bodies will be described in more detail. The illustrated construction for an underground system in FIG. 8 has a support member 80 with an aperture 82 that is roughly dimensioned to allow passage of a conduit 84, such a water or sewer pipe of a communication cable array, and to provide a gap for the adhesive or grouting. Because of the range of tolerance that prevail in such a construction, it is common to need some form of a shim, wedge, or block to align and stabilize the conduit along with maintain the gap before applying the material, such as an adhesive, grout, or cement, to fix the conduit 84 in place. In this illustration, A, B, and C represent multi-dimensional geometric bodies, such as any of the type disclosed in FIGS. 1A through 7B, that are place at different orientations around the conduit 84 within the aperture 82 as needed to align and stabilize the conduit 84.

With reference to FIG. 9, the use of multi-dimensional geometric bodies will be described in more detail in an illustration of a completed construction. In the illustrated construction 90, the underground system illustrated in FIG. 8 is part of an overall construction that may include gravel or dirt fill 92, finer gravel or sand 94, a concrete or asphalt layer 96, and a top plate or grate 98. This construction is typical of what may be found in a street or parking lot. In the illustration, the multi-dimensional geometric bodies A, B, and C are as discussed in connection with FIG. 8. The multi-dimensional geometric bodies D, E and F, which may be any of the type disclosed in FIGS. 1A through 7B, are placed at different orientations as needed to align with the top surface. In this illustration, the spacers D, E, and F serve the additional purposed of stabilizing the gap to prevent structure from floating up due to ground water. If desired, the spacers A, B, C, D, E, and F may be used at any position around the conduit and with the overall structure to maintain spacing and prevent floating up.

Although many materials may satisfy the required strength to be form into multi-dimensional geometric bodies, it presently preferred to form them in an injection molding or extrusion process from a plastic having the strength to resist compression from the weight of the conduit. In some applications, injection molding may be preferred because the product formed in the cavity of the mold may have better tolerance control while extrusion may be preferred for production speeds. While other materials may be suitable for these processes, plastic is believed to possess better resistance to ground water and have a better probability of maintaining the alignment in the event that the surrounding adhesive decomposes or deteriorates.

What is claimed is:

1. A multi-dimensional geometric body comprising:
opposed surfaces that are spaced apart and define a predetermined thickness, each of the opposed surfaces has a geometric shape that includes no more than three right angles; and, a body portion that extends between the opposed surfaces and conforms to the geometric shape of the opposed surfaces.

2. The multi-dimensional geometric body of claim 1 wherein the opposed surfaces have different geometric shapes.

3. The multi-dimensional geometric body of claim 1 wherein the opposed surfaces have the same geometric shapes.

4. The multi-dimensional geometric body of claim 1 wherein the opposed surfaces and the body portion have at least one through hole.

5. The multi-dimensional geometric body of claim 4 wherein the opposed surfaces and the body portion have multiple through holes.

6. The multi-dimensional geometric body of claim 5 wherein the multiple through holes vary in size.

7. The multi-dimensional geometric body of claim 1 wherein the body portion that extends between the opposed surfaces has at least one surface that includes a first portion that extends at a first angle for a defined distance and connects with a second portion that extends at a second.

8. A spacer comprising:
a multi-dimensional geometric body with opposed surfaces that are spaced apart to define a predetermined thickness, each of the opposed surfaces has a geometric shape that includes a maximum of three right angles; and, a body portion that extends between the opposed surfaces and conforms to the geometric shape of the opposed surfaces.

9. A method of producing a spacer with a multi-dimensional geometric body, the method comprising the steps of:
providing a molding tool with a maximum of three right angles;
providing molding material to the molding tool to produce a spacer having a body portion with an exterior having a maximum of three right angles.

10. The method of claim 9, wherein the extrusion material is plastic.

11. The method of claim 9, wherein the molding tool is an extrusion die.

12. The method of claim 11, wherein the extrusion die has a honeycomb pattern that produces a plurality of interstices.

13. The method of claim 12, wherein the interstices vary in size.

14. The method of claim 9, wherein the molding tool is a cavity mold.

15. The method of claim 14, wherein the cavity mold has a honeycomb pattern that produces a plurality of interstices.

16. A multi-dimensional geometric body comprising:
opposed surfaces that are spaced apart to define a predetermined thickness, each of the opposed surfaces has a geometric shape that includes no right angles; and, a body portion extending between the opposed surfaces conforms to the geometric shape of the opposed surfaces.
